(19) United States
(12) Patent Application Publication
(10) Pub. No.: US 2026/0004984 A1
(43) Pub. Date: Jan. 1, 2026

(54) ELECTROMAGNETIC RELAY

(71) Applicant: DENSO ELECTRONICS CORPORATION, Anjo-city (JP)

(72) Inventors: Masatoshi AKAHORI, Anjo-city (JP); Tomoaki TANAKA, Anjo-city (JP)

(21) Appl. No.: 19/317,977

(22) Filed: Sep. 3, 2025

Related U.S. Application Data
(63) Continuation of application No. PCT/JP2024/005591, filed on Feb. 16, 2024.

(30) Foreign Application Priority Data
Mar. 22, 2023 (JP) 2023-045528

(51) Int. Cl. H01H 50/04; H01H 51/06

(52) U.S. Cl. CPC H01H 50/045; H01H 51/06; H01H 2239/034

(57) ABSTRACT

An electromagnetic relay includes a case defines an accommodating space, and a base defines the accommodating space together with the case. A coil is disposed in the accommodating space and generates electromagnetic force when energized. A pair of fixed contactors with one end disposed in the accommodating space and fixed to the base while the other end protrudes outside the accommodating space. The fixed contactors each have a fixed contact. A movable contactor is disposed in the accommodating space and driven by the electromagnetic force generated by the coil to make or break contact with the fixed contacts. The movable contactor includes a movable contact. An adsorbent is disposed within the accommodating space at a location different from a contact point between the fixed contact and the movable contact.

### CROSS REFERENCE TO RELATED APPLICATIONS

The present application is a continuation application of International Patent Application No. PCT/JP2024/005591 filed on Feb. 16, 2024, which designated the U.S. and claims the benefit of priority from Japanese Patent Application No. 2023-045528, filed on Mar. 22, 2023. The disclosures of all the above applications are incorporated herein.

### TECHNICAL FIELD

The present disclosure relates to an electromagnetic relay for opening and closing an electric circuit.

### BACKGROUND

Conventionally, in electromagnetic relays, a moisture-absorbing material is provided in a contact chamber where contacts are housed.

### SUMMARY

An electromagnetic relay according to an aspect of the present disclosure includes a case, a base, a coil, a pair of fixed contactors, a movable contactor and an adsorbent. The case defines an accommodating space, and the base defines the accommodating space together with the case. The coil is arranged in the accommodating space and configured to generate electromagnetic force when energized. The pair of fixed contactors each have one end positioned within the accommodating space and fixed to the base, and another end protruding outside the accommodating space. The pair of fixed contactors each have a fixed contact. The movable contactor is arranged in the accommodating space and has a movable contact configured to be driven by the electromagnetic force generated by the coil to make or break contact with the fixed contact. The adsorbent is disposed within the accommodating space at a location different from a contact point between the fixed contact and the movable contact.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a sectional view illustrating a configuration of an electromagnetic relay according to a first embodiment of the present disclosure.

FIG. 2 is a sectional view taken along line II-II in FIG. 1.

FIG. 3 is a view in which a part of the electromagnetic relay shown in FIG. 1 is extracted, and a perspective view from a viewpoint where a movable contactor can be seen along with a base and various components assembled onto the base.

FIG. 4 is an enlarged view of region R in FIG. 3.

FIG. 5 is a sectional view illustrating an ON state of the electromagnetic relay illustrated in FIG. 2.

### DETAILED DESCRIPTION

According to a comparative example, an electromagnetic relay, in order to prevent poor conductivity due to water adhering to contacts, has a moisture-absorbing material provided on a wall surface of a contact cover that constitutes a contact chamber where the contacts are housed. By adsorbing moisture inside the contact chamber, the adhesion of water to the contacts is suppressed.

When the electromagnetic relay is an open type, the interior and exterior of the housing chamber that accommodates electrical components constituting the electromagnetic relay are connected, allowing outside air to enter the housing chamber. In such open-type electromagnetic relays, when used in cold regions, water vapor may be generated from the coil, causing condensation on the contacts. In such cases, leaving the electromagnetic relay in the OFF state, i.e., with the contacts open, can cause the moisture on the contacts to freeze, leading to poor contact conductivity.

In contrast, by making the case of the electromagnetic relay a sealed structure, completely separating the coil and the contact chamber, and making it a sealed type, the above-mentioned condensation and freezing can be reduced. Additionally, by providing an adsorbent that absorbs moisture in the case, the adherence of water to the contacts can be suppressed.

However, in a structure where the coil and the contact chamber are completely separated as a sealed type, an increase in the number of components may be required to create the sealed structure, as well as an increase in the component processing steps due to the assembly of the sealed structure through welding and other methods. Furthermore, simply placing the adsorbent on the wall surface that constitutes the contact chamber does not sufficiently suppress the adherence of water to the contacts, and once the adsorbent has absorbed moisture, it may no longer be able to absorb any additional moisture.

Although the explanation here used an open-type electromagnetic relay, which is of particular concern, as an example of poor contact conductivity due to water adhering to the contacts, the same issue can arise in sealed-type electromagnetic relays if the contact chamber contains water vapor.

In contrast, according to the present disclosure, an electromagnetic relay is capable of suppressing poor contact conductivity caused by condensation.

An electromagnetic relay according to a first aspect of the present disclosure includes a case, a base, a coil, a pair of fixed contactors, a movable contactor and an adsorbent. The case defines an accommodating space, and the base defines the accommodating space together with the case. The coil is arranged in the accommodating space and configured to generate electromagnetic force when energized. The pair of fixed contactors each have one end positioned within the accommodating space and fixed to the base, and another end protruding outside the accommodating space. The pair of fixed contactors each have a fixed contact. The movable contactor is arranged in the accommodating space and has a movable contact configured to be driven by the electromagnetic force generated by the coil to make or break contact with the fixed contact. The adsorbent is disposed on the pair of fixed contactors, the movable contactor or both fixed and movable contactors, within the accommodating space at a location different from a contact point between the fixed contact and the movable contact.

According to this, even if water vapor is generated from the coil and water vapor is present within the accommodating space due to energization, the adsorbent is placed near the fixed contact, enabling it to adsorb moisture from the contact section. Therefore, condensation on the fixed contactors and the movable contactor can be prevented. Furthermore, the heat generated by the adsorption of moisture can raise the temperature of the fixed contact or the movable contact, thereby preventing condensation on the contacts. Even if water adheres to the fixed contact, the heat prevents the water from freezing.

Additionally, since the adsorbent is positioned on the fixed contactors or movable contactor that serve as current paths, the heat generated during energization can cause the water adsorbed by the adsorbent to desorb. Therefore, even if the adsorbent temporarily adsorbs moisture, it can desorb the moisture during energization, refreshing the adsorption effect of the adsorbent. As a result, the adsorption effect of the adsorbent can be maintained at a high level, allowing it to repeatedly absorb moisture.

Thus, the influence of water vapor present in the accommodating space can be further suppressed, preventing poor contact conductivity more effectively.

According to a second aspect of the present disclosure, the pair of fixed contactors each include a stator that has one end on which the fixed contact is provided and another end serving as an external connection terminal. The adsorbent is positioned on a current path of the stator.

By placing the adsorbent in the part of the stator that constitutes the current path in this manner, it is possible to achieve higher temperatures and thereby promote the desorption of water from the adsorbent.

According a third aspect of the present disclosure, the adsorbent extends towards the other end of the stator on one of the pair of fixed contactors while the adsorbent being in contact with the fixed contact. By extending the adsorbent into the part of the stator that constitutes the current path and allowing it to come into contact with the fixed contact in this manner, moisture in the vicinity of the fixed contact can be more effectively adsorbed. Additionally, the adsorption heat can be transferred to the fixed contact, raising its temperature and thereby suppressing condensation on the contact.

According to a fourth aspect of the present disclosure, the fixed contact is one of two fixed contacts arranged adjacent to each other on one of the pair of fixed contactors. The movable contact of the movable contactor is one of movable contacts including two movable contacts arranged adjacent to each other and configured to be brought into contact with the two fixed contacts. The adsorbent may be disposed between the two fixed contacts and in contact with both the two fixed contacts. By extending the adsorbent into the part of the stator that constitutes the current path and allowing it to come into contact with the fixed contact in this manner, moisture in the vicinity of the fixed contact can be more effectively adsorbed. Additionally, the adsorption heat can be transferred to the fixed contact, raising its temperature and thereby suppressing condensation on the contact.

Embodiments of the present disclosure will be described with reference to the drawings. In the following embodiments, the same reference numerals are assigned to parts that are the same as or equivalent to each other for description.

The embodiments of the present disclosure will be described below with reference to the drawings. In the following embodiments, parts that are identical or equivalent to those described in preceding embodiments are denoted by the same reference numerals, and their descriptions may be omitted. Additionally, in each embodiment, when only a part of the components is described, the components described in the preceding embodiments can be applied to the other parts of the components.

### First Embodiment

An electromagnetic relay according to the present embodiment is used for switching a power supply on and off to electrical devices such as those used in vehicles, and is utilized, for example, in electric vehicles equipped with fuel cells.

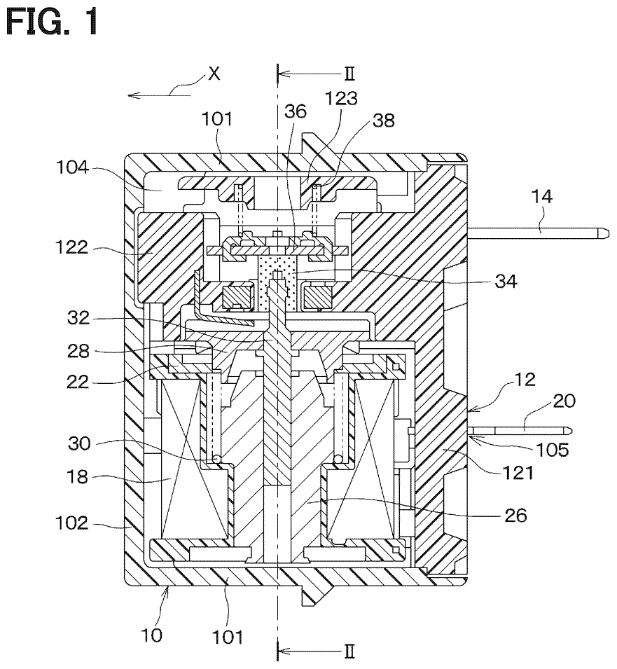

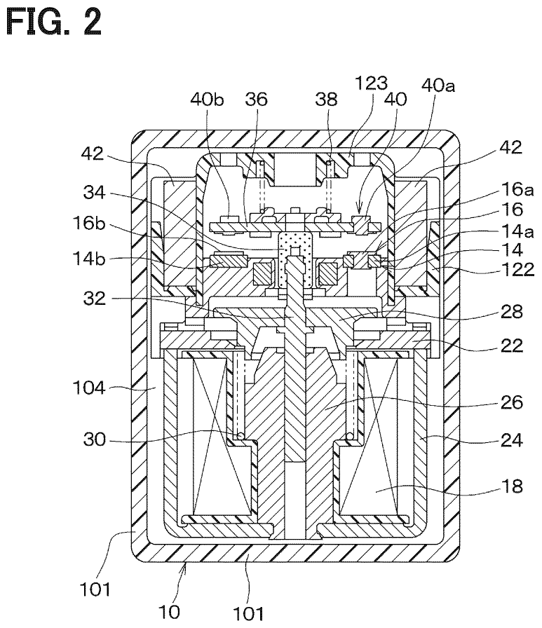

As shown in FIG. 1 and FIG. 2, the electromagnetic relay according to the present embodiment includes a resin case 10. The case 10 has four side walls 101 and one case bottom 102, forming a bottomed rectangular tubular shape. Inside the case 10, a accommodating space 104 is formed. This accommodating space 104 is open to the outside through a vent hole 105 formed in a base 12 near a coil terminals 20.

The resin base 12 is fitted into the case 10 and includes a base bottom 121, a base body 122 that protrudes from the base bottom 121 toward a case bottom 102, and a base spring seat 123 that holds a contact pressure spring 38, which will be described later. The accommodating space 104 is defined by the case 10 and the base bottom 121. The base 12 is formed by insert molding using a pair of stators 14, which will be described later, as inserts.

The base bottom 121 has two terminal insertion holes (not shown) into which the pair of coil terminals 20, which will be described later, are inserted.

When assembling the base 12 to the case 10, the base 12 is inserted into the case 10 by moving the base 12 relative to the case 10 from the right side to the left side in FIG. 1, as indicated by arrow X. Hereinafter, the insertion direction of the base 12 when assembling the base 12 to the case 10 is referred to as a base insertion direction X. The case 10 and the base 12 are adhered together by applying adhesive to their fitting portion.

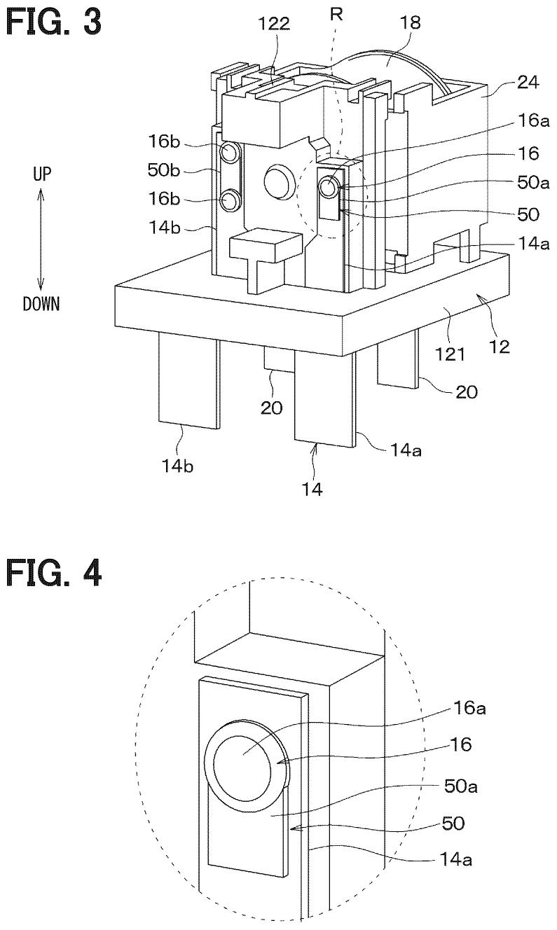

As shown in FIGS. 2 and 3, the pair of stators 14 made of conductive metal plates are fixed to the base 12. As shown in FIGS. 2 and 3, one end of each stator 14 is fixed to the base body 122 and is positioned within the accommodating space 104, while the other end, as shown in FIG. 1, protrudes outside to form an external connection terminal. A fixed contact 16 made of conductive metal is riveted and secured to the end of a stator 14 protruding in the accommodating space 104. The other end of the stator 14 protruding to the external space serves as an external connection terminal connected to an external electrical circuit (not shown). The stator 14 and the fixed contact 16 together constitute a fixed contactor.

Regarding the fixed contacts 16, it is sufficient if one is formed for each stator 14. However, in this embodiment, one stator 14a is provided with only one fixed contact 16a, while the other stator 14b is provided with two fixed contacts 16b. As shown in FIG. 3, the stator 14a has a wider portion forming the external connection terminal, and a narrower portion inside the accommodating space 104. The fixed contact 16a is arranged on the narrower portion. The stator 14b also has a wider portion forming the external connection terminal and a narrower portion inside the accommodating space 104. Along the longitudinal direction of the narrower portion of the stator 14b, the two fixed contacts 16b are arranged side by side at a predetermined distance from each other.

Therefore, the stator 14a makes point contact with a movable contactor, which will be described later, at a single fixed contact 16a. Additionally, the stator 14b is capable of making two-point contact with the movable contactor, which will be described later, through its two fixed contacts 16b.

A cylindrical coil 18, which generates electromagnetic force when energized, is arranged in the accommodating space 104. The pair of coil terminals 20 made of conductive metal are connected to this coil 18.

The coil terminals 20 are inserted into a terminal insertion holes (not shown) formed in the base bottom 121, and their ends protrude outside the electromagnetic relay to form external connection terminals. The coil terminals 20 are connected to an ECU (not shown) via an external harness, and the coil 18 is energized through an external harness and the coil terminals 20.

A disc-shaped plate 22 made of ferromagnetic metal material is arranged between the coil 18 and the base body 122. A yoke 24, which is made of ferromagnetic metal material, is positioned adjacent to the side of the coil 18 that faces away from the base body 122, as well as along the outer periphery of the coil 18. The plate 22 and the yoke 24 are fixed to the base 12.

In the inner peripheral space of the coil 18, a cylindrical fixed core 26 made of ferromagnetic metal material is arranged, and the fixed core 26 is held by the yoke 24.

A disc-shaped movable core 28 made of ferromagnetic metal material is arranged between the base body 122 and the plate 22. Additionally, between the coil 18 and the movable core 28, a return spring 30 is arranged to bias the movable core 28 in a direction away from the fixed core 26.

When the coil 18 is energized, the electromagnetic force generated by the coil 18 causes the movable core 28 to be attracted toward the fixed core 26 against the return spring 30. The plate 22, yoke 24, fixed core 26, and movable core 28 constitute the magnetic path for the magnetic flux induced by the coil 18.

A metal shaft 32 passes through and is fixed to the movable core 28. One end of the shaft 32 extends in the direction away from the fixed core 26, and the end of this one end of the shaft 32 is fitted and fixed to an insulating bushing 34 made of resin with excellent electrical insulating properties. The other end of the shaft 32 is slidably inserted into the fixed core 26.

In the accommodating space 104, a mover 36 made of a conductive metal plate is arranged. Between the mover 36 and the base spring seat 123, the contact pressure spring 38 is arranged to bias the mover 36 toward the insulating bushing 34. A pair of movable contacts 40 made of conductive metal are riveted and fixed to the mover 36 at positions facing the pair of fixed contacts 16. The mover 36 and the movable contacts 40 constitute a movable contactor.

As for the movable contacts 40, it is sufficient to form one for each stator 14. However, in this embodiment, the number of movable contacts 40 corresponds to the number of the fixed contacts 16a and 16b. In other words, one end of the mover 36, which corresponds to the position of the fixed contact 16a, is provided with only one movable contact 40a. On the other end of the mover 36, which corresponds to the position of the fixed contact 16b, there are two movable contacts 40b, although only one is shown in FIG. 2. The mover 36 is made of a plate material as described above. The other end of the mover 36, on which the movable contacts 40b are arranged, branches into a T-shape, and each of the two tips has one movable contact 40b arranged on it. In other words, in the horizontal direction in FIG. 2, or in other words, in the direction in which the movable contact 40a and the movable contacts 40b are aligned, which is the longitudinal direction of the mover 36, the movable contacts 40b are arranged in a direction intersecting, for example, perpendicular to the longitudinal direction of the mover 36, spaced apart at a predetermined distance. Therefore, the movable contact 40a makes a single-point contact with one fixed contact 16a. Additionally, the two movable contacts 40b are capable of making two-point contact with the two fixed contacts 16b.

In the recess of the base body 122, a pair of permanent magnets 42 are arranged to form a magnetic field in the contact-separation areas where the fixed contacts 16 and the movable contacts 40 make and break contact, thereby stretching the arc generated between the fixed contacts 16 and the movable contacts 40. These permanent magnets 42 are arranged facing each other along the alignment direction of the pair of contact-separation areas (the left-right direction in FIG. 2).

The accommodating space 104 can be sealed solely by the case 10 and the base 12. However, using metal or ceramics for the case 10 and the base 12 would necessitate welding, thereby reducing the flexibility in material selection and manufacturing processes. Therefore, in this embodiment, it is designed as an open-type electromagnetic relay, where the space between the case 10 and the base 12 is not sealed, and the coil 18 and the contact section are not completely isolated as in a sealed type. Of course, the issue of poor conductivity due to water adhering to the contact section is a concern, particularly in open types. However, even in sealed-type electromagnetic relays, if water vapor is present in the contact chamber, similar issues can arise. Therefore, it may also be configured as a sealed-type electromagnetic relay.

Furthermore, in this embodiment, as shown in FIGS. 3 and 4, adsorbents 50 are provided near the fixed contacts 16 on the stators 14. Specifically, for the stator 14a, an adsorbent 50a extends from the fixed contact 16a toward the other end of the stator 14a, which constitutes the external connection terminal of the stator 14a, while the adsorbent 50a being in contact with the fixed contact 16a. Additionally, for the stator 14b, the adsorbent 50b extends between the two fixed contacts 16b of the stator 14b, in such a manner that the adsorbent 50b is in contact with both fixed contacts 16b.

The adsorbents 50 only need to be positioned near the fixed contacts 16 of the stators 14 made of metal. However, in this embodiment, the adsorbents 50 are positioned on current paths in the stators 14. Moreover, in a more preferred embodiment, the adsorbents 50 are positioned to be in contact with the fixed contacts 16.

The adsorbents 50 can be made from any material that has an adsorptive effect and can release the adsorbed moisture when heated. Examples of such materials include activated carbon or a material in which a desiccant is mixed with resin. In the present embodiment, activated carbon is used as the adsorbents 50. The activated carbon is applied in a liquid or paste form and then solidified, thereby positioning the adsorbents 50 on the stators 14. Since the adsorbents 50 are formed by applying it, there is no need to provide the space that would be required if the adsorbents 50 were separate components.

As described above, the electromagnetic relay according to the present embodiment is configured in this manner. Next, the operation of the electromagnetic relay according to the present embodiment will be explained.

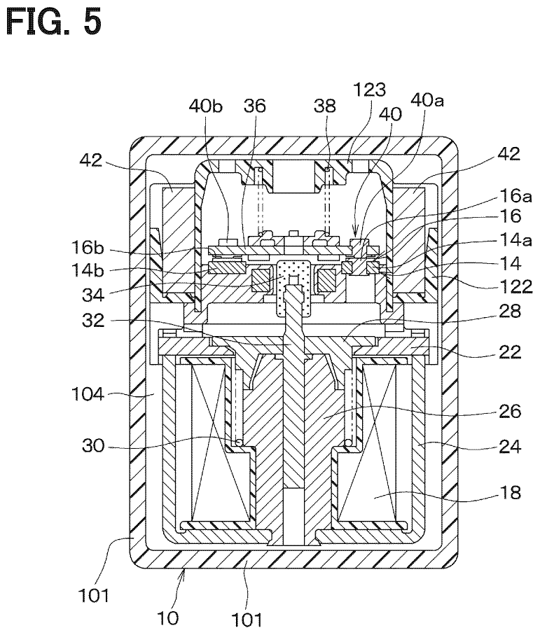

First, when current is supplied to the coil 18, the electromagnetic force overcomes the return spring 30, causing the movable core 28 to be attracted towards the fixed core 26. Consequently, the mover 36 is urged by the contact pressure spring 38 and moves following the movable core 28. As a result, as shown in FIG. 5, the two movable contacts 40 come into contact with the two fixed contacts 16, establishing conductivity between the pair of stators 14.

On the other hand, when the power supply to the coil 18 is cut off, the return spring 30 pushes the movable core 28 and the mover 36 against the contact pressure spring 38, urging them away from the fixed core 26. As a result, as shown in FIG. 2, the two movable contacts 40 are separated from the two fixed contacts 16, interrupting the conductivity between the pair of stators 14.

Here, when the electromagnetic relay is of an open type as in this embodiment, water vapor may be generated from the coil 18 due to energization thereof, resulting in the presence of water vapor within the accommodating space 104. This can potentially lead to condensation on the fixed contacts 16 and the movable contacts 40. However, in the electromagnetic relay of this embodiment, since the adsorbents 50 are placed near the fixed contacts 16, moisture can be adsorbed. Specifically, by positioning the adsorbents 50 in contact with the fixed contacts 16, it is possible to more effectively absorb moisture in the vicinity of the fixed contacts 16.

As a result, condensation on the fixed contacts 16 and the movable contacts 40 can be reduced. Additionally, since the adsorption heat generated by the absorption of moisture can increase the temperature of the fixed contacts 16, condensation on the fixed contacts 16 can be reduced. Even if water adheres to the fixed contacts 16, the adsorption heat can reduce freezing of the water.

Furthermore, since the adsorbents 50 are placed on the stators 14, which serve as the current paths, the heat generated during energization can cause the water absorbed by the adsorbents 50 to desorb. Specifically, if the adsorbents 50 are placed on the parts of the stators 14 that constitute the current paths, they can reach a higher temperature, thereby promoting the desorption of water from the adsorbents 50. As a result, even if the adsorbents 50 have once absorbed moisture, the moisture can be desorbed during energization, thereby refreshing the adsorption effect of the adsorbents 50. Therefore, the adsorption effect of the adsorbents 50 can be maintained at a high level, enabling it to repeatedly absorb moisture.

Thus, the influence of water vapor present in the accommodating space 104 can be suppressed, preventing poor contact conductivity.

### Other Embodiments

The present disclosure is not limited to the embodiments described above and can be appropriately modified within the scope described in the claims.

For example, in the above embodiment, the adsorbents 50 are disposed on the stators 14, but it is also possible to dispose an adsorbent 50 on the mover 36. An adsorbent 50 may be disposed only on the stators 14, only on the mover 36, or on both. When the adsorbent 50 is disposed on the mover 36, the adsorbent 50 can be placed between one movable contact 40a and the other movable contact 40b, or between the two movable contacts 40b. In this case, it is preferable to place the adsorbent 50 so that it is in contact with the movable contact 40a between the movable contact 40a and the movable contact 40b, or in contact with both movable contacts 40b between the two movable contacts 40b, as this allows for better adsorption of water adhered to each of the movable contacts 40a and 40b.

Additionally, in the above embodiments, the case 10 is exemplified as being made of resin, but the case 10 may also be made of metal. Furthermore, in the above embodiments, the base 12 is exemplified as being made of resin, but the base 12 may also be made of ceramic. Depending on the materials of the case 10 and the base 12, it is also possible to make the electromagnetic relay a sealed type. However, if water vapor is present in the accommodating space 104 even in the sealed type, the effect described above can be achieved by providing an adsorbent 50 on the metal that constitutes the current path, as disclosed herein.

Of course, the structure of the electromagnetic relay is merely an example, and other structures may also be employed. Even in such cases, the effect described above can be achieved by providing the adsorbent 50 on the metal parts that constitute the current path of the electromagnetic relay. For example, the adsorbent 50 may be provided at a location different from where the fixed contacts 16 and the movable contacts 40 within the accommodating space 104 come into contact, on at least one of the fixed contactor and the movable contactor.

The constituent element(s) of each of the above embodiments is/are not necessarily essential unless it is specifically stated that the constituent element(s) is/are essential in the above embodiment, or unless the constituent element(s) is/are obviously essential in principle.

Additionally, in the above embodiments, when the number, value, quantity, range, etc., of the elements of the embodiment are mentioned, they are not limited to those specific numbers unless explicitly stated as essential or clearly limited to specific numbers in principle.

Additionally, in the above embodiments, when referring to the shape, positional relationship, etc., of the elements, they are not limited to those specific shapes or positional relationships unless explicitly stated or clearly limited to specific shapes or positional relationships in principle.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. An electromagnetic relay comprising:
a case defining an accommodating space;
a base defining the accommodating space together with the case;
a coil arranged in the accommodating space and configured to generate electromagnetic force when energized;
a pair of fixed contactors each having one end positioned within the accommodating space and fixed to the base, and another end protruding outside the accommodating space, the pair of fixed contactors each having a fixed contact;
a movable contactor arranged in the accommodating space and having a movable contact configured to be driven by the electromagnetic force generated by the coil to make or break contact with the fixed contact; and
an adsorbent disposed on the pair of fixed contactors, the movable contactor or both fixed and movable contactors, within the accommodating space at a location different from a contact point between the fixed contact and the movable contact.

2. The electromagnetic relay according to claim 1, wherein
the adsorbent is provided on the pair of fixed contactors,
the pair of fixed contactors each include a stator that has one end on which the fixed contact is provided and another end serving as an external connection terminal, and
the adsorbent is positioned on a current path of the stator.

3. The electromagnetic relay according to claim 2, wherein
the adsorbent extends towards the other end of the stator on one of the pair of fixed contactors while the adsorbent being in contact with the fixed contact.

4. The electromagnetic relay according to claim 2, wherein
the fixed contact is one of two fixed contacts arranged adjacent to each other on one of the pair of fixed contactors,
the movable contact of the movable contactor is one of movable contacts including two movable contacts arranged adjacent to each other and configured to be brought into contact with the two fixed contacts, and
the adsorbent is disposed between the two fixed contacts and in contact with both the two fixed contacts.
